(19) United States
(12) Patent Application Publication
(10) Pub. No.: US 2026/0133364 A1
(43) Pub. Date: May 14, 2026

(54) OPTICAL ARRAY DEVICE AND METHOD FOR MANUFACTURING THE SAME

(71) Applicant: Electronics and Telecommunications Research Institute, Daejeon (KR)

(72) Inventors: Joong-Seon Choe, Daejeon (KR); Kap-joong Kim, Daejeon (KR); Dong Churl Kim, Daejeon (KR); Minchul Kim, Daejeon (KR); Ju Hee Baek, Daejeon (KR); Junsang Oh, Daejeon (KR); Chun Ju Youn, Daejeon (KR); Kyongchun Lim, Daejeon (KR); Byung-seok Choi, Daejeon (KR)

(73) Assignee: Electronics and Telecommunications Research Institute, Daejeon (KR)

(21) Appl. No.: 19/292,100

(22) Filed: Aug. 6, 2025

(30) Foreign Application Priority Data
Nov. 14, 2024 (KR) 10-2024-0162488
Mar. 27, 2025 (KR) 10-2025-0039594

(51) Int. Cl. G02B 6/12; G02B 6/125; G02B 6/13

(52) U.S. Cl. CPC G02B 6/12004; G02B 6/125; G02B 6/13; G02B 2006/12073; G02B 2006/12126

(57) ABSTRACT

Provided is an optical array device including a substrate, an optical waveguide input section extending in a first direction on the substrate, a cladding surrounding the optical waveguide input section and separating the substrate and the optical waveguide input section from each other on the substrate, and a stray light blocking pattern covering the cladding, wherein a lowermost surface of the stray light blocking pattern may be located at a lower level than a lowermost surface of the optical waveguide input section.

### CROSS-REFERENCE TO RELATED APPLICATIONS

This U.S. non-provisional patent application claims priority under 35 U.S.C. §119 of Korean Patent Application Nos. 10-2024-0162488 filed on Nov. 14, 2024, and 10-2025-0039594, filed on Mar. 27, 2025, the entire contents of which are hereby incorporated by reference.

### BACKGROUND

The present disclosure herein relates to an optical array device and a method for manufacturing the same, and more particularly, to a multi-channel optical array device for use in a photonic integrated circuit (PIC) and a method for manufacturing the same.

With the development of optical communication systems, the demand for a high-performance variable optical attenuator (VOA) is increasing. In particular, it is very important to maintain independent performance of individual channels in a quantum key distribution (QKD) system that requires a high optical attenuation rate and low insertion loss. A photonic integrated circuit (PIC)-based VOA may be configured with a multi-channel parallel structure, and this structure makes it possible to increase the degree of integration of a system and efficiently process signals.

However, when attempting direct optical coupling with a PIC from a laser diode (LD) or optical fiber array, uncoupled light may diffuse into a chip due to a mode mismatch. Here, if such uncoupled light (stray light) is coupled with an adjacent VOA channel, independent characteristics of each channel deteriorate, and, in particular, system performance decreases in an application that requires a high optical attenuation rate, such as QKD. Therefore, researches on structures and methods for effectively blocking the stray light are continuously carried out.

### SUMMARY

The present disclosure provides a multi-channel optical array device having improved stray light blocking characteristics and a method for manufacturing the same.

The purposes of the present disclosure are not limited to the above-mentioned purposes, and other purposes not mentioned would be clearly understood by those skilled in the art from the disclosure below.

An embodiment of the inventive concept provides an optical array device including: a substrate; an optical waveguide input section extending in a first direction on the substrate; a cladding surrounding the optical waveguide input section and separating the substrate and the optical waveguide input section from each other on the substrate; and a stray light blocking pattern covering the cladding, wherein a lowermost surface of the stray light blocking pattern is located at a lower level than a lowermost surface of the optical waveguide input section.

In an embodiment, the stray light blocking pattern may overlap the optical waveguide input section in a second direction intersecting the first direction.

In an embodiment, the stray light blocking pattern may be vertically spaced apart from the substrate.

In an embodiment, the lowermost surface of the stray light blocking pattern may be in contact with an upper surface of the substrate.

In an embodiment, the stray light blocking pattern may include at least one of carbon black, light absorbing polymer, epoxy, chromium (Cr), aluminum (Al), or silver (Ag).

In an embodiment, the optical waveguide input section may include a material having a higher refractive index than the cladding.

In an embodiment of the inventive concept, an optical array device includes: a substrate; optical waveguide input sections extending in a first direction parallel to an upper surface of the substrate and spaced apart from each other in a second direction parallel to the upper surface of the substrate and intersecting the first direction on the substrate; a cladding surrounding the optical waveguide input sections and including a first portion separating the substrate and the optical waveguide input sections from each other and second portions surrounding the optical waveguide input sections on the first portion; and a stray light blocking pattern covering the cladding, wherein the second portions each extend, on the first portion, in a direction perpendicular to the substrate, and a lowermost surface of the stray light blocking pattern is located at a lower level than a lowermost surface of each of the optical waveguide input sections.

In an embodiment, the stray light blocking pattern may be interposed between the optical waveguide input sections that are adjacent in the second direction.

In an embodiment, the stray light blocking pattern may be vertically spaced apart from the substrate.

In an embodiment, the lowermost surface of the stray light blocking pattern may be in contact with an upper surface of the substrate.

In an embodiment, the stray light blocking pattern may include at least one of carbon black, light absorbing polymer, epoxy, chromium (Cr), aluminum (Al), or silver (Ag).

In an embodiment, the optical waveguide input sections may each include a material having a higher refractive index than the cladding.

In an embodiment of the inventive concept, a method for manufacturing an optical array device includes: forming a lower cladding on a substrate; forming, on the lower cladding, optical waveguide input sections extending in a first direction parallel to an upper surface of the substrate and spaced apart from each other in a second direction parallel to the upper surface of the substrate and intersecting the first direction; forming a temporary upper film surrounding the optical waveguide input sections on the lower cladding; forming trenches extending in the second direction by partially removing the lower cladding and the temporary upper film, wherein a remaining portion of the temporary upper film constitutes upper claddings; and forming a stray light blocking pattern by filling the trenches with a stray light blocking material in a gel state and curing the same, wherein the trenches are each interposed between the optical waveguide input sections that are adjacent in the second direction.

In an embodiment, an upper surface of the lower cladding exposed through the trenches may be located at a lower level than a lower surface of each of the optical waveguide input sections.

In an embodiment, the stray light blocking pattern may be vertically spaced apart from the substrate.

In an embodiment, the trenches may penetrate the temporary upper film and the lower cladding and externally expose a portion of the upper surface of the substrate.

In an embodiment, the optical waveguide input sections may each include a material having a higher refractive index than the upper and lower claddings.

In an embodiment, the stray light blocking material may include at least one of carbon black, light absorbing polymer, epoxy, chromium (Cr), aluminum (Al), or silver (Ag).

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a block diagram for describing a variable optical attenuator (VOA) according to the inventive concept;

FIG. 2 is a plan view for describing an optical array device according to an embodiment of the inventive concept;

FIG. 3 is a cross-sectional view, taken along line A-A′ of FIG. 2, for describing an optical array device according to an embodiment of the inventive concept;

FIG. 4 is a cross-sectional view, taken along line A-A′ of FIG. 2, for describing an optical array device according to another embodiment of the inventive concept;

FIG. 5 is a flowchart for describing a method for manufacturing an optical array device according to an embodiment of the inventive concept; and

FIGS. 6 to 9 are cross-sectional views for describing a method for manufacturing an optical array device according to an embodiment of the inventive concept.

### DETAILED DESCRIPTION

Hereinafter, embodiments of the inventive concept will be described with reference to the accompanying drawings so that the configuration and effects of the inventive concept are sufficiently understood. However, the inventive concept is not limited to the embodiments described below, but may be implemented in various forms and may allow various modifications. Rather, these embodiments are provided so that this disclosure will be thorough and complete, and will fully convey the scope of the inventive concept to those skilled in the art. In the accompanying drawings, the dimensions of elements are magnified for convenience, and the scale ratios among the elements may be exaggerated or reduced.

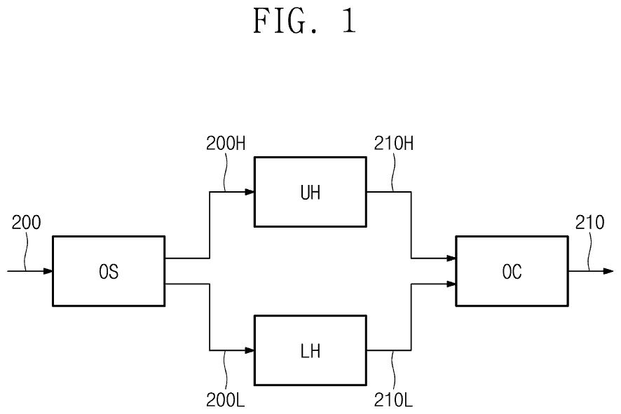

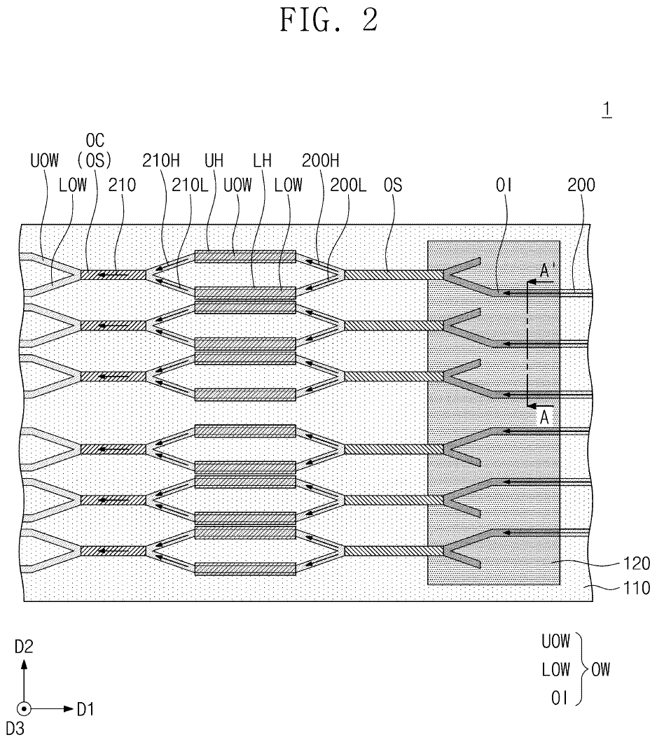

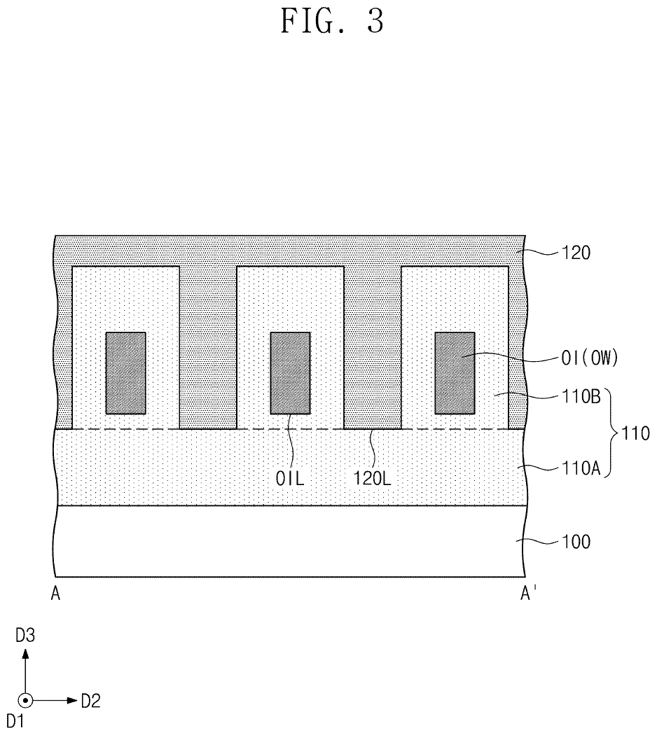

FIG. 1 is a block diagram for describing a variable optical attenuator (VOA) according to the inventive concept. FIG. 2 is a plan view for describing an optical array device according to an embodiment of the inventive concept. FIG. 3 is a cross-sectional view, taken along line A-A′ of FIG. 2, for describing an optical array device according to an embodiment of the inventive concept.

Referring to FIGS. 1, 2, and 3, an optical array device 1 may include a substrate 100, an optical waveguide OW, an optical distributor OS, an optical coupler OC, a cladding 110, and a stray light blocking pattern 120. In other words, the optical array device 1 may include VOA channels. The VOA channels may adjust a phase of light corresponding to each VOA channel to thereby adjust an attenuation rate of the light. Each of the VOA channels may operate independently. For example, the optical array device 1 may include six VOA channels, but is not limited thereto.

For example, the optical array device 1 may be used in a quantum key distribution system, an optical communication system, and the like that are based on a photonic integrated circuit (PIC).

The substrate 100 may be provided. For example, the substrate 100 may include a silicon wafer or glass substrate, but is not limited thereto.

The optical waveguide OW may be disposed on the substrate 100. The optical waveguide OW may include an optical waveguide input section OI, an upper optical waveguide UOW, and a lower optical waveguide LOW spaced apart from the upper optical waveguide UOW in a second direction D2. The optical waveguide OW may extend in a first direction D1 and may be spaced apart from the substrate 100 in a third direction D3. The optical waveguide OW may be provided in plurality, and each of a plurality of optical waveguides OW may be spaced apart from each other in the second direction D2. Each of the plurality of optical waveguides OW spaced apart from each other in the second direction D2 may constitute a portion of a different VOA channel.

In the present disclosure, the first direction D1 may represent a direction parallel to an upper surface of the substrate 100, the second direction D2 may represent a direction parallel to the upper surface of the substrate 100 and intersecting the first direction D1, and the third direction D3 may represent a direction perpendicular to the upper surface of the substrate 100. In other words, the third direction D3 may be orthogonal to the first direction D1 and the second direction D2.

In a single optical waveguide OW, the upper optical waveguide UOW and the lower optical waveguide LOW may be provided in plurality. A plurality of upper optical waveguides UOW and lower optical waveguides LOW may be connected to the optical coupler OC or the optical distributor OS so as to constitute a single optical waveguide OW.

The optical waveguide input section OI, the upper optical waveguide UOW, and the lower optical waveguide LOW may extend in the first direction D1. The optical waveguide input section OI, the upper optical waveguide UOW, and the lower optical waveguide LOW may be provided in plurality in correspondence to the plurality of VOA channels.

Light emitted from a laser diode (LD) or optical fiber array may be coupled with (or incident on) the optical waveguide input section OI, and incident light 200 coupled with (or incident on) the optical waveguide input section OI may be reflected in the optical waveguide OW and may travel along the optical waveguide OW. The incident light 200 may travel along the optical waveguide input section OI, the optical distributor OS, the upper and lower optical waveguides UOW and LOW, and the optical coupler OC and may become output light 210, and the output light 210 transferred along the optical waveguide OW may be transferred to an optical device or the like.

The optical waveguide OW may include a material having a higher refractive index than the cladding 110. For example, the optical waveguide OW may include a silicon oxide or silicon nitride, but is not limited thereto.

The optical distributor OS may be provided between the optical waveguide input section OI and the upper optical waveguide UOW and lower optical waveguide LOW and between the upper optical waveguides UOW and the lower optical waveguides LOW that are adjacent to each other. The optical distributor OS may connect the optical waveguide input section OI to the upper optical waveguide UOW and lower optical waveguide LOW and connect the upper optical waveguides UOW to the lower optical waveguides LOW that are adjacent to each other.

The optical distributor OS may distribute the incident light 200 or the output light 210 received through the optical waveguide input section OI to first upper light 200H that travels along the upper optical waveguide UOW and first lower light 200L that travels along the lower optical waveguide LOW.

The first upper light 200H may become second upper light 210H while passing through the upper optical waveguide UOW, and the first lower light 200L may become second lower light 210L while passing through the lower optical waveguide LOW. The second upper light 210H and the second lower light 210L will be described later.

The optical coupler OC may be connected to the upper optical waveguide UOW and the lower optical waveguide LOW. The optical coupler OC may connect the upper optical waveguides UOW and the lower optical waveguides LOW that are adjacent to each other.

The optical coupler OC may couple the second upper light 210H with the second lower light 210L as a single ray of output light 210. In some cases, the optical coupler OC and the optical distributor OS may be arranged together.

An upper heater UH may be disposed on the upper optical waveguide UOW, and a lower heater LH may be disposed on the lower optical waveguide LOW. The upper heater UH and the lower heater LH may each be provided in plurality in correspondence to the plurality of VOA channels or the plurality of upper and lower optical waveguides UOW and LOW. A plurality of upper heaters UH and lower heaters LH may be independently controlled.

The upper heater UH may transfer heat to the first upper light 200H traveling along the upper optical waveguide UOW, and the lower heater LH may transfer heat to the first lower light 200L traveling along the lower light waveguide LOW.

The first upper light 200H that has passed through the upper heater UH may become second upper light 210H, and the first lower light 200L that has passed through the lower heater LH may become second lower light 210L. The second upper light 210H may have a phase and output different from those of the first upper light 200H, and the second lower light 210L may have a phase and output different from those of the first lower light 200L.

A phase difference between the first upper light 200H traveling along the upper optical waveguide UOW and the first lower light 200L traveling along the lower optical waveguide LOW may be controlled by controlling a temperature of the lower heater LH or the upper heater UH, and an output ratio between the second upper light 210H and the second lower light 210L may thus be adjusted.

The upper heater UH and the lower heater LH may adjust an output ratio and a phase of light passing through the VOA channels. For example, the upper heater UH, the lower heater LH, and the VOA channels may constitute a Mach-Zehnder interferometer as a whole.

The cladding 110 may surround the optical waveguide OW, the optical distributor OS, and the optical coupler OC. The cladding 110 may separate the substrate 100 and the optical waveguide OW, the optical distributor OS, and the optical coupler OC from each other in the third direction D3. The cladding 110 may surround the plurality of VOA channels. The cladding 110 may provide a condition for total reflection of light in the optical waveguide OW and may prevent the light in the optical waveguide OW from leaking to the outside.

The cladding 110 may include a material having a lower refractive index than the optical waveguide OW. For example, the cladding 110 may include a silicon oxide, but is not limited thereto.

Referring to FIGS. 2 and 3, the cladding 110 may include second portions 110B surrounding the optical waveguide OW and a first portion 110A separating the substrate 100 and the second portions 110B from each other. The first portion 110A and the second portions 110B may be formed of substantially the same material and thus may have an unclear boundary therebetween, and may integrally constitute the cladding 110. For example, the first portion 110A may separate the substrate 100 and the optical waveguide input section OI from each other in the third direction D3, and the second portions 110B may surround the optical waveguide input section OI.

The first portion 110A may be provided on the substrate 100 and may extend in the first direction D1 and the second direction D2. The first portion 110A may be in contact with the substrate 100.

The second portions 110B may extend in the first direction D1 along the optical waveguide OW on the first portion 110A and extend in the third direction D3. The second portions 110B may be spaced apart from each other in the second direction D2 and may not cover a portion of an upper surface of the first portion 110A.

Upper surfaces of the second portions 110B may be located at a higher level than an upper surface of the optical waveguide OW, and lower surfaces of the second portions 110B or the upper surface of the first portion 110A may be located at a lower level than a lower surface of the optical waveguide OW. For example, the upper surfaces of the second portions 110B may be located at a higher level than an upper surface of the optical waveguide input section OI, and the lower surfaces of the second portions 110B or the upper surface of the first portion 110A may be located at a lower level than a lower surface OIL of the optical waveguide input section OI.

The stray light blocking pattern 120 may be provided on the cladding 110. The stray light blocking pattern 120 may cover the upper surface and side surfaces of each of the second portions 110B and the upper surface of the first portion 110A not covered with the second portions 110B. The stray light blocking pattern 120 may extend on the cladding 110 in the first direction D1 and the second direction D2.

The stray light blocking pattern 120 may be spaced apart from the substrate 100 in the third direction D3. In other words, the stray light blocking pattern 120 may be vertically spaced apart from the substrate 100.

The stray light blocking pattern 120 may overlap the optical waveguide OW in the second direction D2. In other words, the stray light blocking pattern 120 may be interposed between the optical waveguides OW that are adjacent in the second direction D2. For example, the stray light blocking pattern 120 may overlap the optical waveguide input section OI in the second direction D2 and may be interposed between the optical waveguide input sections OI that are adjacent in the second direction D2.

A lowermost surface 120L of the stray light blocking pattern 120 may be in contact with the upper surface of the first portion 110A and may be located at a lower level than the lower surface of the optical waveguide OW. For example, the lowermost surface 120L of the stray light blocking pattern 120 may be located at a lower level than the lower surface OIL of the optical waveguide input section OI.

Therefore, the stray light blocking pattern 120 may absorb up to stray light that leaks from the lower surface of the optical waveguide OW or the lower surface OIL of the optical waveguide input section OI, and thus the optical array device 1 according to the inventive concept may have improved stray light blocking characteristics.

In other words, since the lowermost surface 120L of the stray light blocking pattern 120 is located at a lower level than the lower surface of the optical waveguide OW or the lower surface OIL of the optical waveguide input section OI, a stray light absorption rate of the stray light blocking pattern 120 may be improved compared to the case where the the lowermost surface 120L of the stray light blocking pattern 120 is located at a higher level than the lower surface of the optical waveguide OW or the lower surface OIL of the optical waveguide input section OI. Accordingly, the optical array device 1 according to the inventive concept may have improved stray light blocking characteristics.

The stray light blocking pattern 120 may include a material that absorbs light leaking from the optical waveguide OW due to a mode mismatch or the like. For example, the stray light blocking pattern 120 may include at least one of carbon black, light absorbing polymer, epoxy, chromium (Cr), aluminum (Al), or silver (Ag).

Since the stray light blocking pattern 120 including a light absorbing material covers the cladding 110 surrounding the optical waveguide input sections OI and is interposed between the optical waveguide input sections OI that are adjacent in the second direction D2, stray light that has failed to be coupled (or incident) due to a mode mismatch may be prevented from diffusing into a chip when light is coupled with (or incident on) the optical waveguide input section OI from an external LD or optical fiber array. Therefore, the optical array device according to the inventive concept may improve stray light blocking characteristics by preventing stray light that has failed to be coupled (or incident) due to a mode mismatch from being coupled with (or incident on) adjacent VOA channels. Accordingly, the optical array device according to the inventive concept may maintain independent characteristics of each of the VOA channels, and performance of a system (e.g., QKD system) that requires a high optical attenuation rate may be improved.

The stray light blocking pattern 120 may be formed by curing gel that includes a stray light blocking material, but is not limited thereto and will be described later.

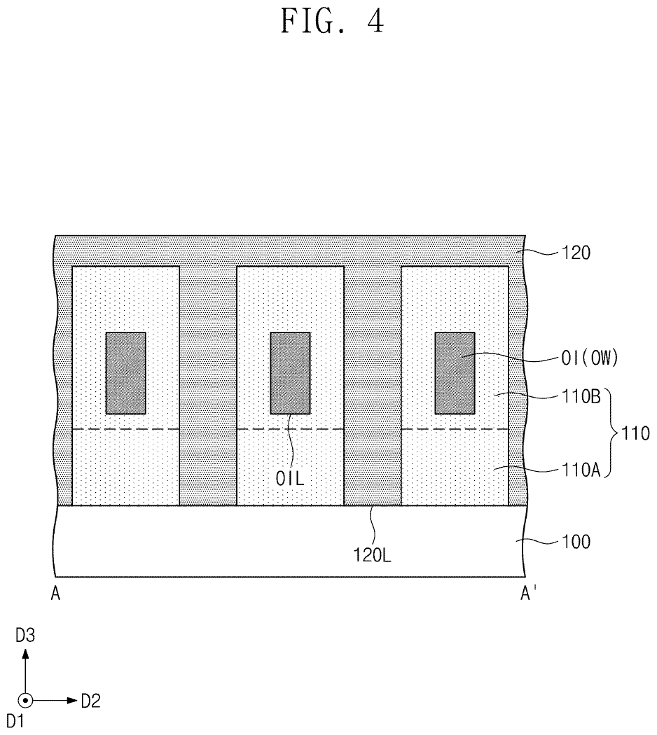

FIG. 4 is a cross-sectional view, taken along line A-A′ of FIG. 2, for describing an optical array device according to another embodiment of the inventive concept. The following descriptions will be provided with a focus on difference with the above-described optical array device according to an embodiment of the inventive concept. For conciseness, detailed descriptions of components that are the same as or similar to the above-described components may not be provided.

Unlike the above embodiment, the first portions 110A may each be provided on the substrate 100 and extend in the first direction D1. The first portions 110A may not cover a portion of the upper surface of the substrate 100.

The second portions 110B may cover upper surfaces of the first portions 110A and extend in the third direction D3.

Unlike the above embodiment, the stray light blocking pattern 120 may cover the upper surface of the substrate 100, side surfaces of each of the first portions 110A, and the upper surfaces and side surfaces of each of the second portions 110B.. The lowermost surface 120L of the the stray light blocking pattern 120 may be in contact with the upper surface of the substrate 100.

The stray light blocking pattern 120 may be interposed between the first portions 110A that are adjacent in the second direction D2 and the second portions 110B that are adjacent in the second direction D2. The stray light blocking pattern 120 may separate the first portions 110A and the second portions 110B that are adjacent in the second direction D2 from each other.

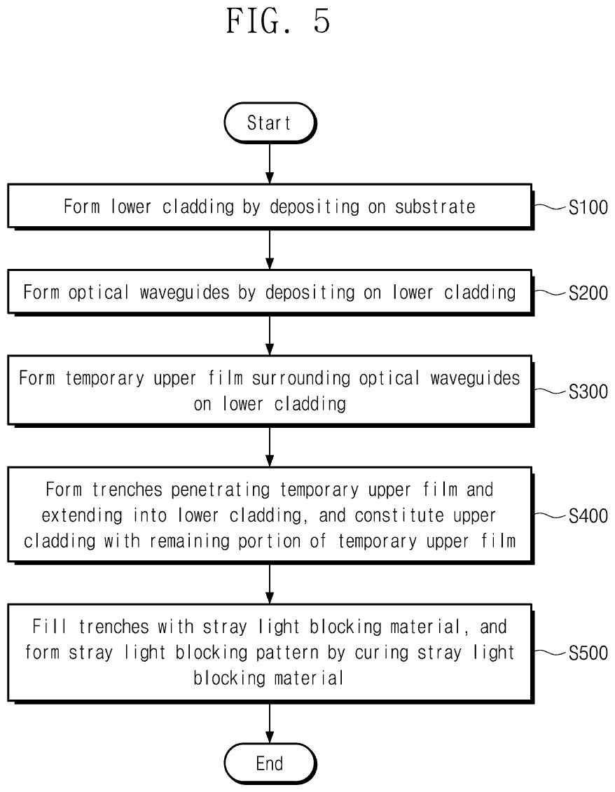

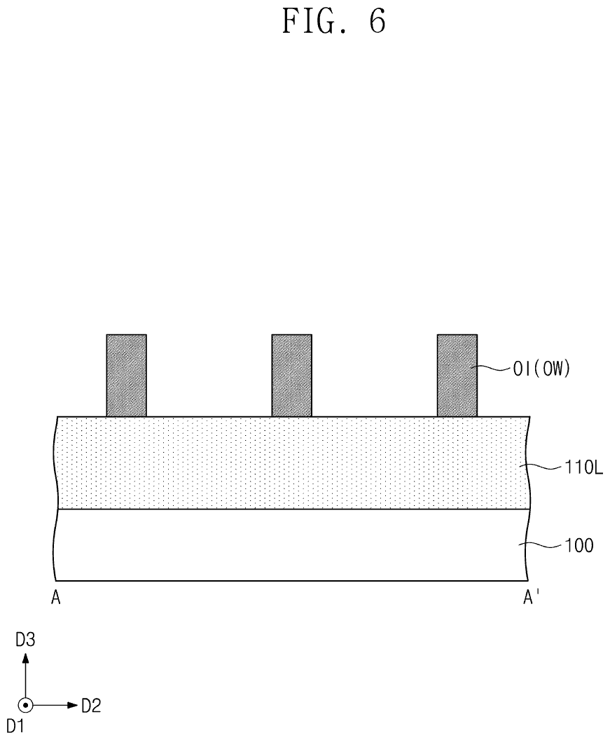

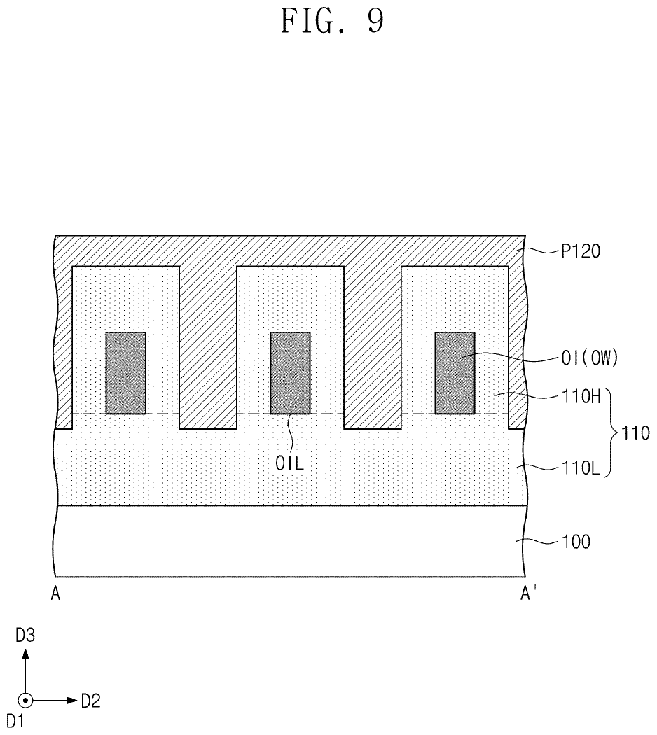

FIG. 5 is a flowchart for describing a method for manufacturing an optical array device according to an embodiment of the inventive concept. FIGS. 6 to 9 are cross-sectional views for describing a method for manufacturing an optical array device according to an embodiment of the inventive concept. In more detail, FIGS. 6 to 9 are cross-sectional view taken along line A-A′ of FIG. 2. For conciseness, detailed descriptions of components that are the same as or similar to the above-described components may not be provided.

Referring to FIGS. 5 and 6, the substrate 100 may be prepared. A lower cladding 110L may be formed by being deposited on the substrate 100 (S100). The lower cladding 110L may cover the substrate 100 and extend in the first direction D1 and the second direction D2.

For example, the lower cladding 110L may be deposited through a physical vapor deposition (PVD) or chemical vapor deposition (CVD) process.

The lower cladding 110L may include a material having a lower refractive index than the optical waveguide OW. For example, the lower cladding 110L may include a silicon oxide, but is not limited thereto.

The optical waveguides OW including the optical waveguide input section OI, the upper optical waveguide UOW (FIG. 2), and the lower optical waveguide LOW (FIG. 2) may be formed by being deposited on the lower cladding 110L after the lower cladding 110L is formed (S200).

In detail, forming of the optical waveguides OW may include: depositing an optical waveguide film (not shown) on the lower cladding 110L; and forming the optical waveguides OW by patterning the optical waveguide film (not shown).

For example, the optical waveguide film (not shown) may be deposited through a physical vapor deposition (PVD) or chemical vapor deposition (CVD) process.

The optical waveguide film (not shown) may include a material having a higher refractive index than the lower cladding 110L. For example, the optical waveguide film (not shown) may include a silicon oxide or silicon nitride, but is not limited thereto.

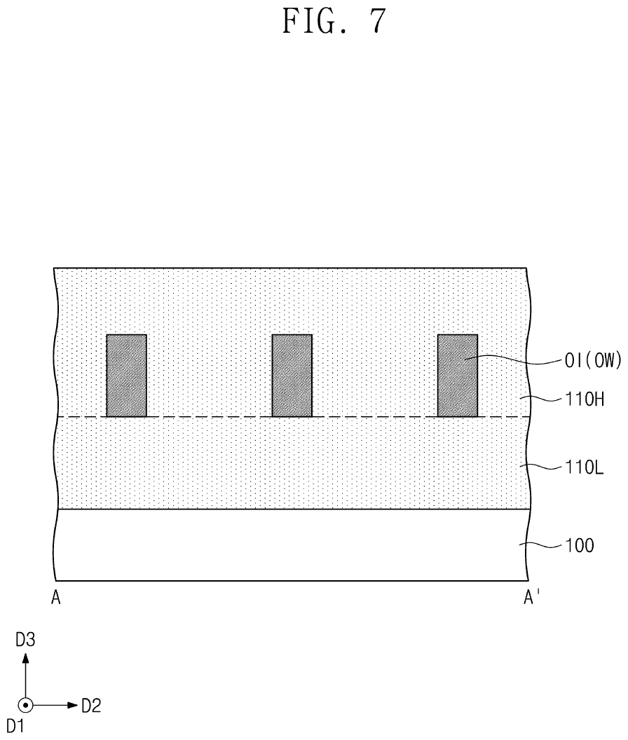

Referring to FIGS. 5 and 7, a temporary upper film P110H surrounding each of the optical waveguides OW may be formed on the lower cladding 110L after the optical waveguides OW are formed (S300). The temporary upper film P110H may cover an upper surface of the lower cladding 110L and the upper surface and side surfaces of each of the optical waveguides OW.

For example, the temporary upper film P110H may be deposited through a physical vapor deposition (PVD) or chemical vapor deposition (CVD) process.

The temporary upper film P110H may include a material having a lower refractive index than the optical waveguide OW. For example, the temporary upper film P110H may include a silicon oxide, but is not limited thereto.

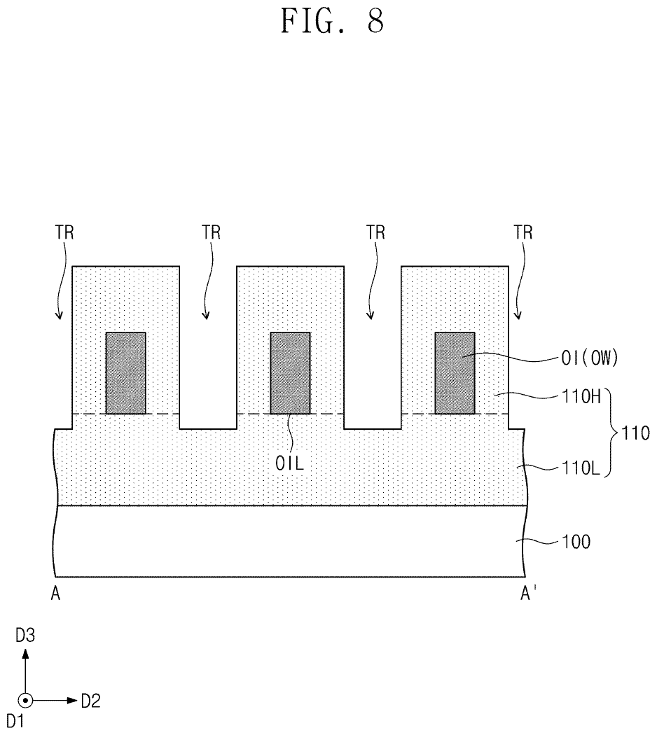

Referring to FIGS. 5 and 8, upper claddings 110H may be formed by partially removing the temporary upper film P110H after the temporary upper film P110H is formed (S400).

In detail, forming of the upper claddings 110H may include: forming trenches TR that partially penetrate an upper surface of the temporary upper film P110H and extend into the lower cladding 110L by partially removing the temporary upper film P110H; and constituting the upper claddings 110H with a remaining portion after removal by the trenches TR. For example, the trenches TR may be formed through an anisotropic etching process.

The temporary upper film P110H may be divided by the trenches TR into a plurality of upper claddings 110H. In other words, the trenches TR may separate the plurality of upper claddings 110H from each other in the second direction D2.

A portion of the upper surface of the lower cladding 110L may be recessed by the trenches TR and exposed to the outside. The trenches TR may be interposed between the optical waveguides OW that are adjacent in the second direction D2. The trenches TR may extend in the first direction D1 along the optical waveguide OW between adjacent optical waveguides OW. For example, the trenches TR may each have a shape of a bar extending in the first direction D1.

The upper surface of the lower cladding 110L exposed by the trenches TR may be located at a lower level than the lower surface OIL of each of the optical waveguides OW. In other words, the trenches TR may extend into the lower cladding 110L up to a lower level than the lower surface OIL of each of the optical waveguides OW. For example, the upper surface of the lower cladding 110L exposed by the trenches TR may be located at a lower level than the lower surface OIL of each of the optical waveguide input sections OI.

Referring to FIGS. 2, 5, and 9, the stray light blocking pattern 120 filling the trenches TR may be formed after the upper claddings 110H are formed (S500).

In detail, forming of the stray light blocking pattern 120 may include: forming a stray light blocking material P120 filling the trenches TR; and forming the stray light blocking pattern 120 by curing the stray light blocking material P120.

The stray light blocking material P120 may fill the trenches TR and cover upper surfaces of the upper claddings 110H.

The stray light blocking material P 120 may include a material that absorbs stray light leaking from the optical waveguide OW due to a mode mismatch or the like. The stray light blocking material P120 may be provided in a form of gel. For example, the stray light blocking material P120 may include at least one of carbon black, light absorbing polymer, epoxy, chromium (Cr), aluminum (Al), or silver (Ag).

For example, the stray light blocking material P120 may be cured using a furnace. A temperature of the furnace may be about 80 degrees to about 120 degrees.

Since the upper claddings 110H surround the optical waveguide OW or the optical waveguide input section OI and the stray light blocking pattern 120 fills the trenches TR between the upper claddings 110H, light that has failed to be coupled with the optical waveguide OW or the optical waveguide input section OI may be prevented from diffusing into a PIC or entering other VOA channels. Therefore, the optical array device 1 according to the inventive concept may have improved stray light blocking characteristics.

In an optical array device according to the inventive concept, a trench is formed on a cladding surrounding an optical waveguide, and a stray light blocking pattern filling the trench is formed, and thus light that has failed to be coupled with the optical waveguide may be prevented from diffusing into a PIC or coupling with (or being incident on) other VOA channels. Therefore, the optical array device according to the inventive concept may have improved stray light blocking characteristics.

The effects of the inventive concept are not limited to the above-mentioned effects, and other effects not mentioned would be clearly understood by those of ordinary skill in the art from the disclosure below.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. An optical array device comprising:
a substrate;
an optical waveguide input section extending in a first direction parallel to an upper surface of the substrate on the substrate;
a cladding disposed on the substrate and surrounding the optical waveguide input section, the cladding spacing the optical waveguide input section from the substrate; and
a stray light blocking pattern covering the cladding,
wherein a lowermost surface of the stray light blocking pattern is located at a level lower than a lowermost surface of the optical waveguide input section.

2. The optical array device of claim 1, wherein the stray light blocking pattern overlaps the optical waveguide input section in a second direction parallel to the upper surface of the substrate and intersecting the first direction.

3. The optical array device of claim 1, wherein the stray light blocking pattern is vertically spaced apart from the substrate.

4. The optical array device of claim 1, wherein the lowermost surface of the stray light blocking pattern is in contact with the upper surface of the substrate.

5. The optical array device of claim 1, wherein the stray light blocking pattern includes at least one of carbon black, light absorbing polymer, epoxy, chromium (Cr), aluminum (Al), or silver (Ag).

6. The optical array device of claim 1, wherein the optical waveguide input section includes a material having a higher refractive index than the cladding.

7. An optical array device comprising:
a substrate;
a plurality of optical waveguide input sections extending in a first direction parallel to an upper surface of the substrate and spaced apart from each other in a second direction parallel to the upper surface of the substrate and intersecting the first direction on the substrate;
a cladding surrounding the plurality of optical waveguide input sections and including a first portion separating the substrate and the optical waveguide input sections from each other and second portions surrounding the optical waveguide input sections on the first portion; and
a stray light blocking pattern covering the cladding,
wherein the second portions each extend, on the first portion, in a direction perpendicular to the substrate, and
a lowermost surface of the stray light blocking pattern is located at a level lower than a lowermost surface of each of the plurality of optical waveguide input sections.

8. The optical array device of claim 7, wherein the stray light blocking pattern is interposed between the plurality of optical waveguide input sections that are adjacent in the second direction.

9. The optical array device of claim 7, wherein the stray light blocking pattern is vertically spaced apart from the substrate.

10. The optical array device of claim 7, wherein the lowermost surface of the stray light blocking pattern is in contact with an upper surface of the substrate.

11. The optical array device of claim 7, wherein the stray light blocking pattern includes at least one of carbon black, light absorbing polymer, epoxy, chromium (Cr), aluminum (Al), or silver (Ag).

12. The optical array device of claim 7, wherein the plurality of optical waveguide input sections each include a material having a higher refractive index than the cladding.

13. A method for manufacturing an optical array device, comprising:
forming a lower cladding on a substrate;
forming, on the lower cladding, a plurality of optical waveguide input sections extending in a first direction parallel to an upper surface of the substrate and spaced apart from each other in a second direction parallel to the upper surface of the substrate and intersecting the first direction;
forming a temporary upper film surrounding the plurality of optical waveguide input sections on the lower cladding;
forming trenches extending in the second direction by partially removing the lower cladding and the temporary upper film, wherein a remaining portion of the temporary upper film constitutes upper claddings; and
forming a stray light blocking pattern by filling the trenches with a stray light blocking material in a gel state and curing the same,
wherein the trenches are each interposed between the plurality of optical waveguide input sections that are adjacent in the second direction.

14. The method of claim 13, wherein an upper surface of the lower cladding exposed through the trenches is located at a level lower than a lower surface of each of the plurality of optical waveguide input sections.

15. The method of claim 13, wherein the stray light blocking pattern is vertically spaced apart from the substrate.

16. The method of claim 13, wherein the trenches penetrate the temporary upper film and the lower cladding and externally expose a portion of the upper surface of the substrate.

17. The method of claim 13, wherein the plurality of optical waveguide input sections each include a material having a higher refractive index than the upper and lower claddings.

18. The method of claim 13, wherein the stray light blocking material includes at least one of carbon black, light absorbing polymer, epoxy, chromium (Cr), aluminum (Al), or silver (Ag).
